(19) United States
(12) Patent Application Publication
(10) Pub. No.: US 2023/0335098 A1
(43) Pub. Date: Oct. 19, 2023

(54) DEVICE AND METHOD FOR CONTROLLING FEEDBACK OF ELECTRONIC PERCUSSION INSTRUMENT AND NON-TRANSITORY COMPUTER-READABLE RECORDING MEDIUM

(71) Applicant: Roland Corporation, Shizuoka (JP)

(72) Inventors: Toshiharu KIMURA, Hamamatsu, Shizuoka (JP); Atsushi Hoshiai, Shizuoka (JP)

(73) Assignee: Roland Corporation, Shizuoka (JP)

(21) Appl. No.: 17/787,595

(22) PCT Filed: Dec. 27, 2019
(86) PCT No.: PCT/JP2019/051589

§ 371 Date: Jun. 21, 2022

(51) Int. Cl. G10H 3/14; G10H 1/02; G10H 3/26

(52) U.S. Cl. CPC G10H 3/26; G10H 1/02; G10H 3/146; G10H 3/143; G10H 2220/525

(57) ABSTRACT

This device for controlling feedback of an electronic percussion instrument includes an acquisition part that acquires a feedback signal of a musical sound of the electronic percussion instrument emitted through an amplifier and a speaker, and a processing circuit that performs uncorrelated processing on the feedback signal on the basis of information indicating a control amount, and outputs a signal after the uncorrelated processing to the amplifier.

### TECHNICAL FIELD

The disclosure relates to a device and a method for controlling feedback.

### RELATED ART

Conventionally, in an effector having a feedback loop, the return (feedback) level of the output of the effector is controlled by the control amount of the performance operator (see, for example, Patent Literature 1). Further, there is a method of setting the gain of the amplifier so that the gain of the feedback loop is close to 1 (see, for example, Patent Literature 2).

### CITATION LIST

### Patent Literature

[Patent Literature 1] Japanese Patent Lain-Open No. H6-043863
[Patent Literature 2] Japanese Patent Lain-Open No. 2015-176059

### SUMMARY

### Technical Problem

Howling caused by feedback may be used as a kind of performance sound, but may also be recognized as an unpleasant sound. In the conventional technology, controlling howling has not been considered.

The disclosure provides a device and a method for controlling feedback of an electronic percussion instrument capable of controlling howling.

### Solution to Problem

An embodiment of the disclosure provides a device for controlling feedback, which includes: an acquisition part that acquires a feedback signal of a musical sound of an electronic percussion instrument emitted through an amplifier and a speaker; and a processing circuit that performs uncorrelated processing on the feedback signal based on information indicating a control amount, and outputs a signal after the uncorrelated processing to the amplifier. In addition to the device for controlling feedback, embodiments of the disclosure may include a control method and a program thereof.

### BRIEF DESCRIPTION OF THE DRAWINGS

In FIG. 1, (A) and (B) show an electronic snare drum, which is an example of the electronic percussion instrument.

FIG. 2 shows a configuration example of the device for controlling feedback according to an embodiment.

FIG. 3 is a diagram illustrating processing in the DSP shown in FIG. 2.

In FIG. 4, (A) and (B) are illustration diagrams of an example of the resonance circuit.

In FIG. 5, (A) shows a comparative example having no uncorrelated circuit (frequency shifter), and (B) shows a configuration example in which the resonance circuit (BPF) and the uncorrelated circuit (frequency shifter) are used.

FIG. 6 is an illustration diagram of the action of the frequency shift.

In FIG. 7, (A) and (B) show an electronic cajon, which is an example of an electronic percussion instrument.

### DESCRIPTION OF THE EMBODIMENTS

A device for controlling feedback according to an embodiment includes an acquisition part that acquires a feedback signal of a musical sound emitted through an amplifier and a speaker, and a processing circuit that performs uncorrelated processing on the feedback signal based on information indicating a control amount, and outputs a signal after the uncorrelated processing to the amplifier.

In the device for controlling feedback according to an embodiment, the uncorrelated processing may include a processing of shifting a frequency of the feedback signal in a magnitude and a direction indicated as the control amount. In this case, a configuration may be adopted in which a signal of the musical sound has a predetermined center frequency, and the processing circuit acquires the feedback signal having a center frequency different from the predetermined center frequency, and shifts the center frequency of the feedback signal to the predetermined center frequency by the uncorrelated processing.

In the device for controlling feedback according to an embodiment, the uncorrelated processing may include a processing of shifting a pitch of the feedback signal in a magnitude and a direction indicated as the control amount. Alternatively, the uncorrelated processing may include a processing of delaying the feedback signal for a time indicated as the control amount.

Further, in the device for controlling feedback according to an embodiment, a configuration may be adopted in which the processing circuit performs the uncorrelated processing when a predetermined event occurs. Further, the device for controlling feedback according to an embodiment may further include an input device for information indicating a magnitude of the control amount, and the input device includes at least one of an operator and a sensor.

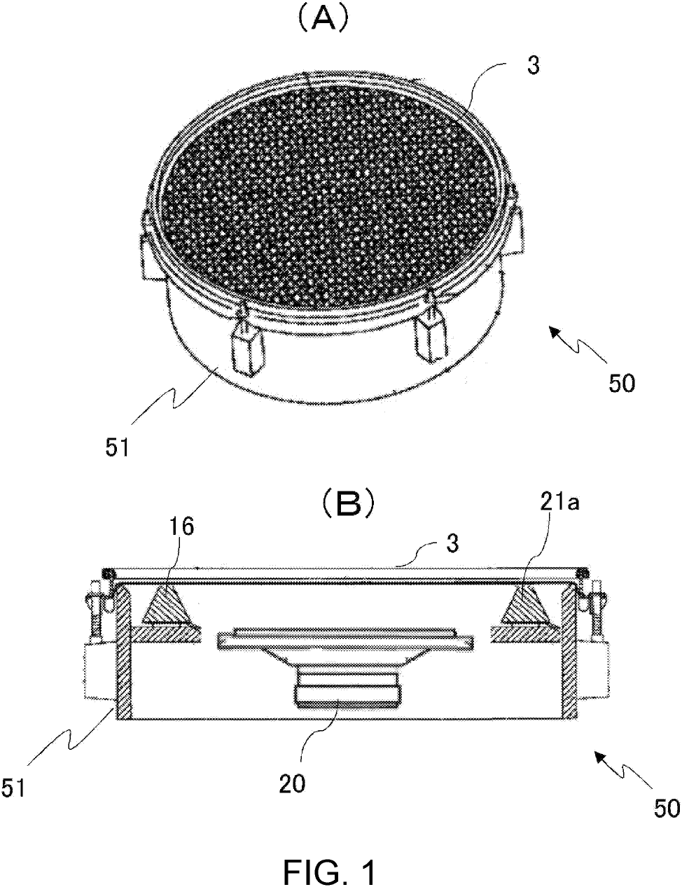

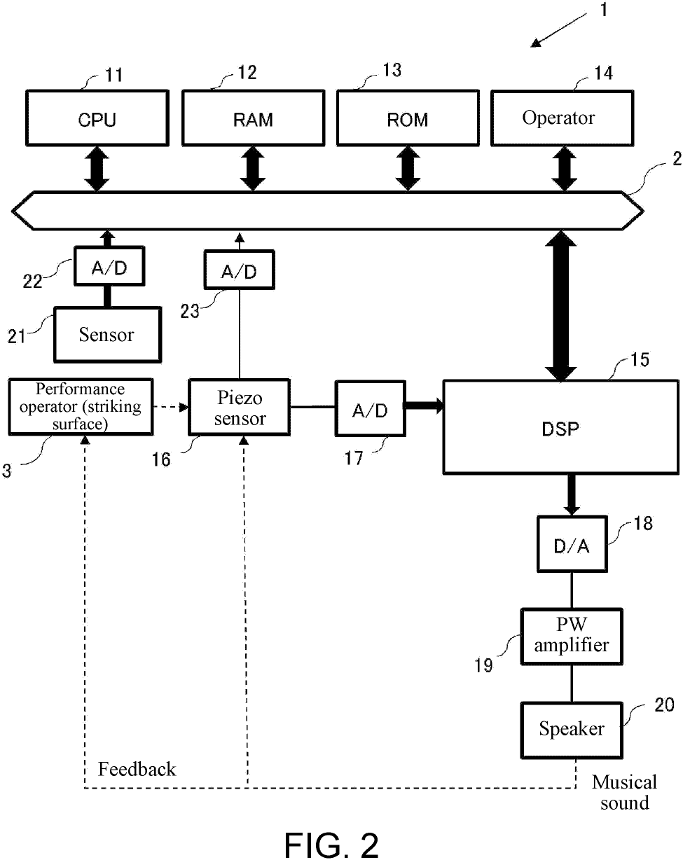

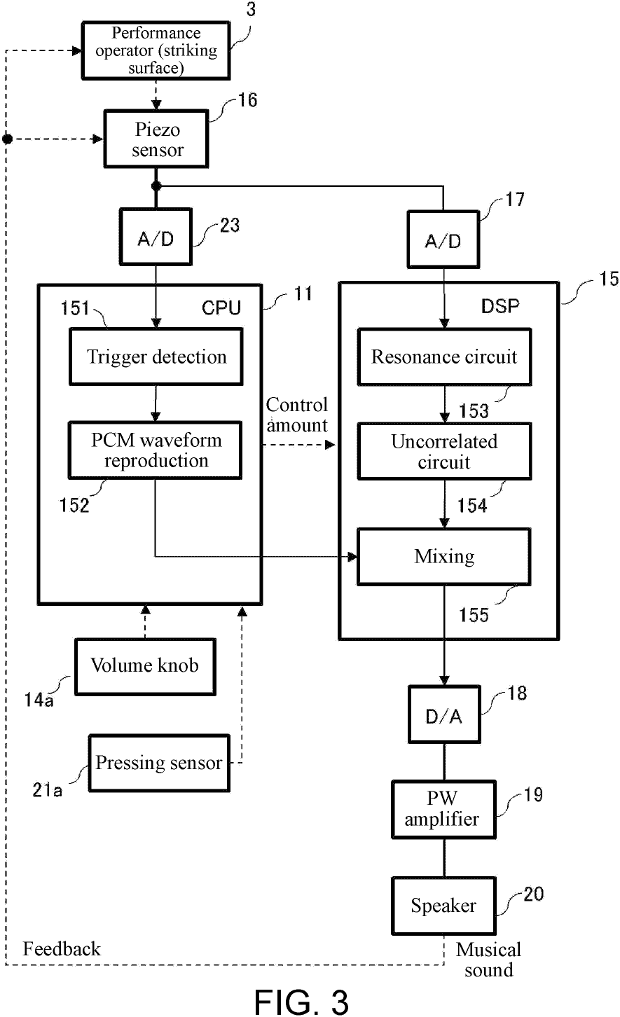

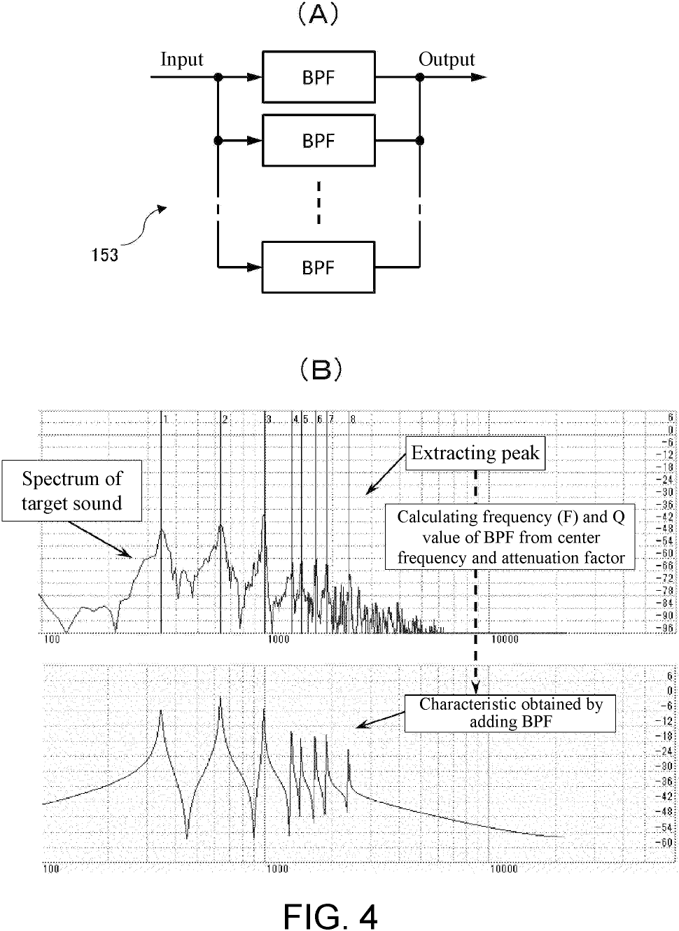

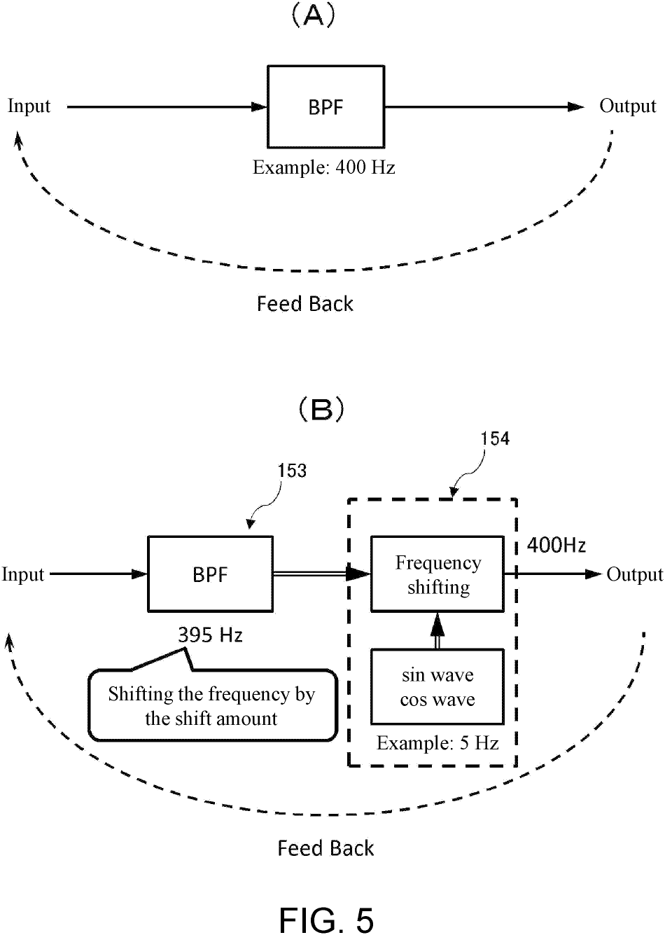

Hereinafter, embodiments of the device for controlling feedback and its control method will be described with reference to the drawings. The configuration of the embodiment is an example, and the disclosure is not limited to the configuration of the embodiment. In FIG. 1, (A) and (B) show an electronic snare drum, which is an example of the electronic percussion instrument. FIG. 2 shows a configuration example of the device for controlling feedback according to an embodiment. FIG. 3 is a diagram illustrating processing in the DSP shown in FIG. 1. The device 1 for controlling feedback is included in a control device of an electronic musical instrument, and controls a feedback signal of a musical sound of the electronic musical instrument.

Here, the electronic musical instrument is a musical instrument including a performance operator that vibrates due to operation. For example, the electronic musical instrument may be a stringed instrument or a percussion instrument. Stringed instruments include vibrating strings such as guitars and violins. Percussion instruments include bass drums, snare drums, Japanese drums, drums, cajons, percussions, or the like, and include a striking surface that vibrates when hit. However, the electronic musical instrument may be other than these examples.

In the embodiment, a case where the electronic musical instrument is an electronic snare drum, which is an example of the electronic percussion instrument, will be described. In (A) and (B) of FIG. 1, an electronic snare drum 50 has a cylindrical housing 51 whose inside is hollow, and a striking surface 3 is stretched over an opening on the upper side of the housing 51. Inside the housing 51, a speaker 20 is disposed toward the back surface of the striking surface 3. Further, a piezo sensor 16 for detecting the vibration of the striking surface 3 and a pressing sensor 21a are disposed on the back side of the striking surface 3 in the housing 51. The speaker 20 is fixed to the housing 51 by a fixture (not shown). Further, the vibration of the speaker 20 is fed back to the piezo sensor 16 via the housing 51.

In FIG. 2, the device 1 for controlling feedback of the electronic snare drum 50 includes a central processing unit (CPU) 11 that controls the overall operation of the electronic snare drum 50. The CPU 11 is connected to a random access memory (RAM) 12, a read only memory (ROM) 13, an operator 14, a digital signal processor (DSP) 15, and a sensor 21 via a bus 2.

The RAM 12 is used as a work area of the CPU 11 and a storage area for programs and data. The ROM 13 is used as a storage area for programs and data. The RAM 12 and the ROM 13 are examples of a storage device (storage medium). The operator 14 is a key, a button, a knob, a switch, or the like for inputting or setting various information such as setting information related to the electronic musical instrument. The sensor 21 is a sensor that detects a predetermined physical quantity. The operator 14 includes, for example, a knob 14a for adjusting the volume of the musical sound emitted from the speaker 20 (FIG. 3). The sensor 21 includes, for example, the pressing sensor 21a that measures the pressing force and is disposed at a predetermined position of the electronic musical instrument (for example, a place on the striking surface 3 that is not hit when being played) (FIG. 3).

The device 1 for controlling feedback includes the piezo sensor (also referred to as a piezoelectric sensor or a piezoelectric element) 16 for detecting the vibration of the striking surface 3 of the electronic musical instrument. The electric signal indicating the vibration of the striking surface 3 detected by the piezo sensor 16 is converted into a digital signal by an A/D converter 17 and input to the DSP 15. The DSP 15 outputs a musical sound signal corresponding to the digital signal input to the DSP 15 to a D/A converter 18. The musical sound signal is converted into an analog signal by the D/A converter 18, amplified by a power amplifier (PW amplifier 19), and emitted from the speaker 20. The air pressure generated by the sound emitted from the speaker 20 vibrates the striking surface 3 (excitation), and the component due to the vibration is included in the output of the piezo sensor 16. In this way, the musical sound emitted from the speaker 20 is fed back. There is also another feedback path in which the vibration of the speaker 20 is detected by the piezo sensor 16 via the housing 51.

The processing performed in the DSP 15 will be described with reference to FIG. 3. When the striking surface 3 is hit, the piezo sensor 16 outputs a signal indicating the vibration of the striking surface 3, and the signal is converted into a digital signal by the A/D converter 17 and an A/D converter 23, and is input to the CPU 11 and the DSP 15. The DSP 15 performs the following processing by executing a program. The DSP 15 is an example of the “acquisition part” and the “processing circuit.” The CPU 11 is an example of the “processor” and the “control circuit.”

The CPU 11 receives a digital signal from the A/D converter 23 and detects that the striking surface 3 has been hit (trigger detection 151). Then, the CPU 11 performs reproduction processing 152 of a pulse code modulation (PCM) waveform corresponding to the digital signal. The musical sound signal obtained by the reproduction processing 152 is input to mixing 155. The CPU 11 receives a digital signal from the A/D converter 23 and detects that the striking surface 3 has been hit (trigger detection 151). Then, the CPU 11 performs reproduction processing 152 of a pulse code modulation (PCM) waveform corresponding to the digital signal. The musical sound signal obtained by the reproduction processing 152 is input to a mixing 155. Further, the signal from the piezo sensor 16 is converted into a digital signal by the A/D converter 17 and input to the DSP 15. The DSP 15 operates as a device having a resonance circuit (equalizer) 153, an uncorrelated circuit 154, and the mixing 155. The signal that has been subjected to the mixing 155 is input to the D/A converter 18 and converted into an analog signal. The analog signal is amplified by the PW amplifier 19 (an example of the amplifier) and emitted from the speaker 20.

The signal (feedback signal) indicating the vibration of the striking surface 3 and the housing 51 generated by the sound emission is detected by the piezo sensor 16, converted into a digital signal by the A/D converters 17 and 23, and input to the CPU 11 and the DSP 15.

In FIG. 4, (A) and (B) are illustration diagrams of an example of the resonance circuit 153. As shown in (A) of FIG. 4, the resonance circuit 153 is a bandpass filter (BPF) sound source, and each harmonic (partial sound) component is configured by a BPF in order to reproduce the sound of a percussion instrument (snare drum). That is, the resonance circuit 153 has a configuration in which multiple BPFs having different cutoff frequencies are connected in parallel. The frequency component of the input signal changes depending on how the striking surface 3 (pad) is tapped, and the change is reflected in the timbre.

As shown in (B) of FIG. 4, the frequency (F) and Q value of the BPF are set based on the center frequency and the attenuation factor so as to match the spectrum of the target sound. The output of the resonance circuit 153 is a value obtained by adding the outputs of each BPF, and is a signal having the characteristics of the feedback signal waveform.

The output signal of the resonance circuit 153 is subjected to uncorrelated processing by the uncorrelated circuit 154. The uncorrelated circuit 154 is any one of a frequency shifter, a pitch shifter, and a delay circuit. The uncorrelated processing is a processing in which the feedback signal has neither positive nor negative correlation with the original musical sound signal.

When the uncorrelated circuit 154 is a frequency shifter, the center frequency of the output signal of the resonance circuit 153 is shifted in the magnitude and the direction indicated by the control amount. For example, when the control amount indicates that the frequency is increased by 5 Hz, the uncorrelated circuit 154 (frequency shifter) shifts the center frequency in the direction of increasing by 5 Hz. However, 5 Hz is an example, and the shift amount may be smaller or larger than 5 Hz.

When the uncorrelated circuit 154 is a pitch shifter, the uncorrelated processing is performed in which the pitch of the output signal of the resonance circuit 153 is shifted in the magnitude (for example, 10 cents) and the direction indicated by the control amount. Further, when the uncorrelated circuit 154 is a delay circuit, the uncorrelated processing is performed in which the pitch of the output signal of the resonance circuit 153 is delayed by the magnitude (for example, 3 msec) indicated by the control amount. In the following description, the case where the uncorrelated circuit 154 is a frequency shifter will be described.

(A) of FIG. 5 is a diagram showing a comparative example having no uncorrelated circuit 154 (frequency shifter). For example, when the center frequency of a musical sound signal is 400 Hz, howling occurs due to repeated feedback of the 400 Hz signal, and an unpleasant abnormal noise such as “beep” is generated.

(B) of FIG. 5 shows a configuration example in which the resonance circuit (BPF) 153 and the uncorrelated circuit (frequency shifter) 154 are used. The frequency shifter performs a frequency shift of increasing the frequency of the signal from the resonance circuit 153 by 5 Hz to 400 Hz. The resonance circuit 153 (BPF) has a cutoff frequency of 395 Hz, which is smaller by the control amount of 5 Hz, and is configured to output a signal having a center frequency of 395 Hz.

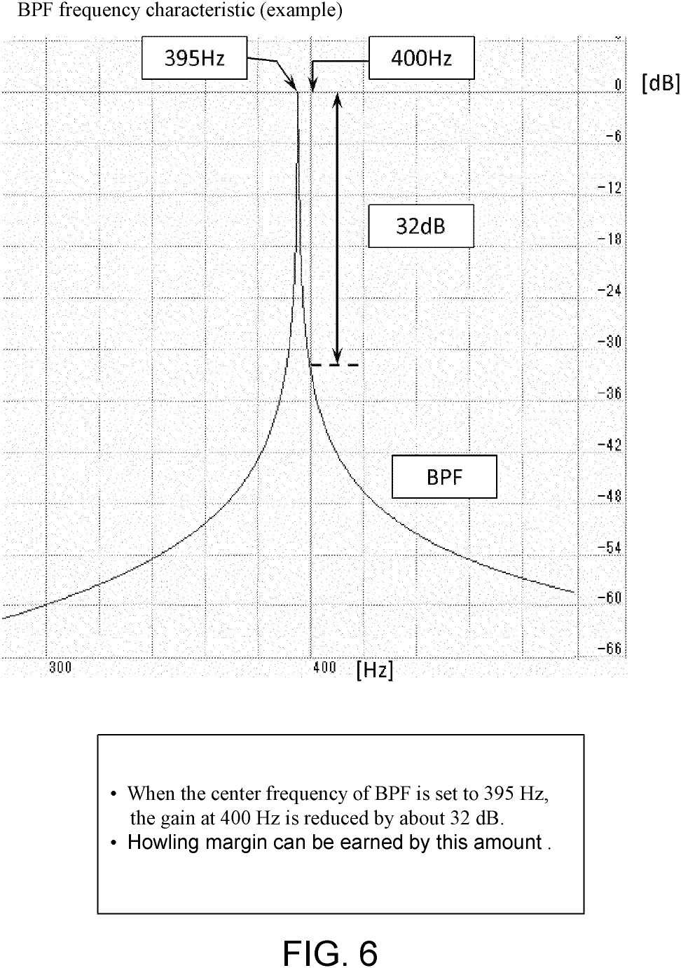

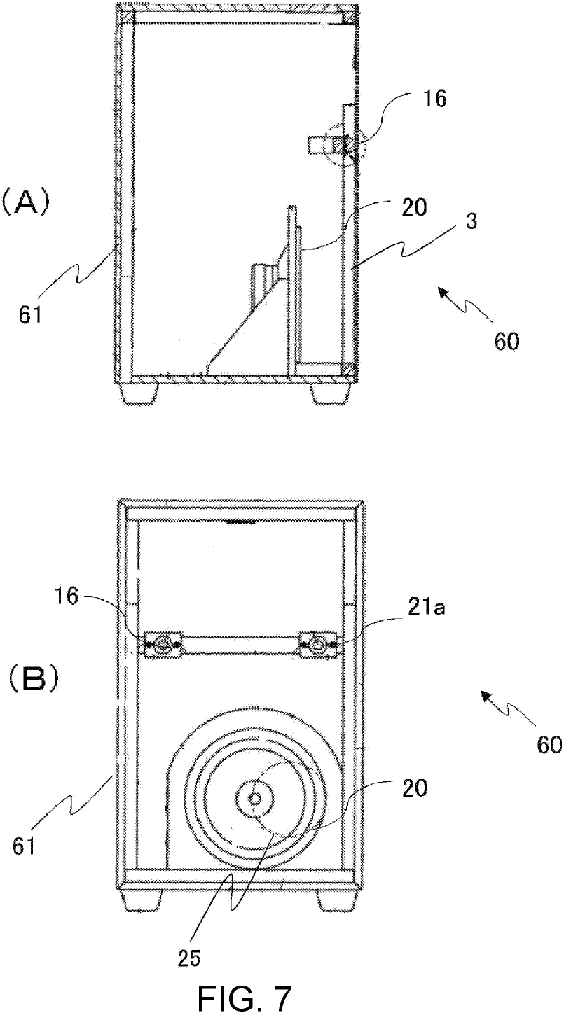

By setting the cutoff frequency of the resonance circuit 153 (BPF) to 395 Hz with respect to the frequency of the output signal of 400 Hz, it is possible to prevent a specific frequency component from being repeatedly amplified and causing an abnormal noise due to howling (by cutting off the feedback loop). Further, when the frequency characteristic of the BPF is the center frequency of 395 Hz shown in FIG. 6, the gain when the frequency is shifted to 400 Hz is reduced by about 32 dB. Howling margin can be earned by this amount.

As shown in FIG. 3, the output signal of the uncorrelated circuit 154 is mixed with the reproduction signal of the PCM waveform by the mixing 155, output to the speaker 20, is subjected to the D/A converter 18 and the PW amplifier 19, and finally connected to the speaker 20. Due to the uncorrelated processing, it is output from the speaker 20 as a sound related to the feedback signal in a state where a sound without abrupt change continues for a while (long).

The switch 31 shown in FIG. 2 can be turned on by a predetermined event, for example, by operating the volume knob 14a or pressing the pressing sensor 21a. For example, when the volume knob 14a is operated so as to increase the volume, the degree of the uncorrelated processing may be weakened so that the feedback sound is sustained. Further, by pressing the pressing sensor 21a, the uncorrelated processing may be weakened so that the feedback sound is sustained. As a result, even though the percussion instrument is an instrument with attenuated sound, the sound can be sustained, and the range of performance expression as a percussion instrument is expanded.

Further, the control amount, that is, the frequency, the pitch shift amount or the delay amount, may be changed according to the degree of operation of the operator 14 such as the volume knob 14a and the strength of the pressing force measured by the pressing sensor 21a (the signal intensity detected by the sensor 21). For example, when the operation amount of the volume knob 14a exceeds a predetermined threshold value, the shift amount may be increased from 5 Hz to 10 Hz, and the gain may be further lowered. The operator 14 and the sensor 21 are examples of the “input device.”

In the embodiment, the electronic snare drum 50 is exemplified as an example of an electronic percussion instrument. (A) and (B) of FIG. 7 show an electronic cajon 60 as an example of another electronic percussion instrument to which the device 1 for controlling feedback of the electronic percussion instrument can be applied. The electronic cajon 60 has a rectangular parallelepiped housing 61 whose inside is hollow, and a striking surface 3 is provided on the front surface of the housing 61. The speaker 20 is disposed on the bottom inside the housing 61. Further, the piezo sensor 16 and the pressing sensor 21a are fixedly disposed inside the housing 61. A hole 25 for emitting sound from the speaker 20 is provided in the lower part of the front surface of the electronic cajon 60.

According to the embodiment described above, when the switch 31 is turned off, the range of performance of the electronic percussion instrument can be expanded by howling to the extent that it does not cause unpleasant feelings. In addition, when there is a possibility that an abnormal noise may be generated due to howling, the switch 31 is turned on by pressing the pressing sensor 21a or operating the volume knob 14a to perform the uncorrelated processing. As a result, it is possible to avoid the generation of an abnormal noise due to howling. Further, the magnitude of the control amount may be changed by operating the input device (operator 14, sensor 21). The configurations shown in the embodiments may be appropriately combined in the range not deviating from the purpose.

### REFERENCE SIGNS LIST

1: Device for controlling feedback
11: CPU
12: RAM
13: ROM
14: Operator
15: DSP
21: Sensor
50: Electronic snare drum
60: Electronic cajon
153: Resonance circuit
154: Uncorrelated circuit

What is claimed is:

1. A device for controlling feedback of an electronic percussion instrument, comprising:
an acquisition part that acquires a feedback signal of a musical sound of the electronic percussion instrument emitted through an amplifier and a speaker; and
a processing circuit that performs uncorrelated processing on the feedback signal based on information indicating a control amount, and outputs a signal after the uncorrelated processing to the amplifier.

2. The device for controlling feedback of the electronic percussion instrument according to claim 1, wherein the uncorrelated processing comprises a processing of shifting a frequency of the feedback signal in a magnitude and a direction indicated as the control amount.

3. The device for controlling feedback of the electronic percussion instrument according to claim 2, wherein a signal of the musical sound has a predetermined center frequency, and
the processing circuit acquires the feedback signal having a center frequency different from the predetermined center frequency, and shifts the center frequency of the feedback signal to the predetermined center frequency by the uncorrelated processing.

4. The device for controlling feedback of the electronic percussion instrument according to claim 1, wherein the uncorrelated processing comprises a processing of shifting a pitch of the feedback signal in a magnitude and a direction indicated as the control amount.

5. The device for controlling feedback of the electronic percussion instrument according to claim 1, wherein the uncorrelated processing comprises a processing of delaying the feedback signal for a time indicated as the control amount.

6. The device for controlling feedback of the electronic percussion instrument according to claim 1, wherein the processing circuit performs the uncorrelated processing when a predetermined event occurs.

7. The device for controlling feedback of the electronic percussion instrument according to claim 1, further comprising an input device for information indicating a magnitude of the control amount.

8. A method for controlling feedback of an electronic percussion instrument, wherein an information processing device performs:
acquiring a feedback signal of a musical sound of the electronic percussion instrument emitted through an amplifier and a speaker; and
performing uncorrelated processing on the feedback signal based on information indicating a control amount, and outputting a signal after the uncorrelated processing to the amplifier.

9. A non-transitory computer-readable recording medium, recording a program that causes a computer to perform processing of:
acquiring a feedback signal of a musical sound of the electronic percussion instrument emitted through an amplifier and a speaker; and
performing uncorrelated processing on the feedback signal based on information indicating a control amount, and outputting a signal after the uncorrelated processing to the amplifier.

10. A device for controlling feedback, comprising:
an acquisition part that acquires a feedback signal of a musical sound emitted through an amplifier and a speaker; and
a processing circuit that performs uncorrelated processing on the feedback signal based on information indicating a control amount, and outputs a signal after the uncorrelated processing to the amplifier.

11. The method for controlling feedback of the electronic percussion instrument according to claim 8, wherein the uncorrelated processing comprises a processing of shifting a frequency of the feedback signal in a magnitude and a direction indicated as the control amount.

12. The method for controlling feedback of the electronic percussion instrument according to claim 11, wherein a signal of the musical sound has a predetermined center frequency, and
the method further comprises acquiring the feedback signal having a center frequency different from the predetermined center frequency, and shifting the center frequency of the feedback signal to the predetermined center frequency by the uncorrelated processing.

13. The method for controlling feedback of the electronic percussion instrument according to claim 8, wherein the uncorrelated processing comprises a processing of shifting a pitch of the feedback signal in a magnitude and a direction indicated as the control amount.

14. The method for controlling feedback of the electronic percussion instrument according to claim 8, wherein the uncorrelated processing comprises a processing of delaying the feedback signal for a time indicated as the control amount.

15. The method for controlling feedback of the electronic percussion instrument according to claim 8, further comprising performing the uncorrelated processing when a predetermined event occurs.

16. The non-transitory computer-readable recording medium according to claim 9, wherein the uncorrelated processing comprises a processing of shifting a frequency of the feedback signal in a magnitude and a direction indicated as the control amount.

17. The non-transitory computer-readable recording medium according to claim 16, wherein a signal of the musical sound has a predetermined center frequency, and
the program further comprises acquiring the feedback signal having a center frequency different from the predetermined center frequency, and shifting the center frequency of the feedback signal to the predetermined center frequency by the uncorrelated processing.

18. The non-transitory computer-readable recording medium according to claim 9, wherein the uncorrelated processing comprises a processing of shifting a pitch of the feedback signal in a magnitude and a direction indicated as the control amount.

19. The non-transitory computer-readable recording medium according to claim 9, wherein the uncorrelated processing comprises a processing of delaying the feedback signal for a time indicated as the control amount.

20. The non-transitory computer-readable recording medium according to claim 9, wherein the program further comprises performing the uncorrelated processing when a predetermined event occurs.
